(19) United States
(12) Patent Application Publication
(10) Pub. No.: US 2005/0154786 A1
(43) Pub. Date: Jul. 14, 2005

(54) Ordering updates in remote copying of data

(75) Inventor: David Michael Shackelford, Tucson, AZ (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(73) Assignee: International Business Machines Corporation

(21) Appl. No.: 10/754,740

(22) Filed: Jan. 9, 2004

(51) Int. Cl. G06F 15/16

(52) U.S. Cl. 709/217

(57) ABSTRACT

Provided are a method, system, and article of manufacture, wherein in certain embodiments a plurality of updates from at least one host are received by at least one storage unit, and wherein a received update includes a first indicator that indicates an order in which the received update was generated by a host. A second indicator is associated with the received update based on an order in which the received update was received by a storage unit. The plurality of updates received by the at least one storage unit are aggregated. The aggregated updates are ordered, wherein the ordered updates can be consistently copied.

### CROSS-REFERENCE TO RELATED APPLICATIONS

This application is related to the following co-pending and commonly-assigned patent application filed on the same date herewith, and which is incorporated herein by reference in its entirety: “Maintaining Consistency for Remote Copy using Virtualization,” having attorney docket no. SJO920030038US1.

### BACKGROUND OF THE INVENTION

1. Field

The present disclosure relates to a method, system, and an article of manufacture for ordering updates in remote copying of data.

2. Description of the Related Art

Information technology systems, including storage systems, may need protection from site disasters or outages. Furthermore, information technology systems may require features for data migration, data backup, or data duplication. Implementations for disaster or outage recovery, data migration, data backup, and data duplication may include mirroring or copying of data in storage systems. In certain information technology systems, one or more host applications may write data updates to the primary storage control, where the written data updates are copied to the secondary storage control. In response to the primary storage control being unavailable, the secondary storage control may be used to substitute the unavailable primary storage control.

When data is copied from a primary storage control to a secondary storage control, the primary storage control may send data updates to the secondary storage control. In certain implementations, such as in asynchronous data transfer, the data updates may not arrive in the same order in the secondary storage control when compared to the order in which the data updates were sent by the primary storage control to the secondary storage control. In certain situations, unless the secondary storage control can determine an appropriate ordering of the received data updates, the data copied to the secondary storage control may be inconsistent with respect to the data stored in the primary storage control.

In certain implementations, data updates may include timestamps to facilitate the ordering of the data updates at the secondary storage control. In certain other implementations, one or more consistency groups of the data updates may be formed at the secondary storage control, such that, updates to storage volumes coupled to the secondary storage control with respect to data updates contained within a consistency group may be executed in parallel without regard to order dependencies within the time interval of the consistency group. For example, if data updates A, B and C belong to a first consistency group of data updates, and data updates D and E belong to a next consistency group of data updates, then the data updates A, B, and C may be executed in parallel without regard to order dependencies among the data updates A, B, and C. However, while the data updates D and E may be executed in parallel without regard to order dependencies among the data updates D and E, the execution of the data updates D and E must be after the execution of the data updates A, B, and C in the first consistency group. Other implementations may quiesce host applications coupled to the primary storage control to copy data consistently from the primary to the secondary storage control.

### SUMMARY OF THE PREFERRED EMBODIMENTS

Provided are a method, system, and article of manufacture, wherein in certain embodiments a plurality of updates from at least one host are received by at least one storage unit, and wherein a received update includes a first indicator that indicates an order in which the received update was generated by a host. A second indicator is associated with the received update based on an order in which the received update was received by a storage unit. The plurality of updates received by the at least one storage unit are aggregated. The aggregated updates are ordered, wherein the ordered updates can be consistently copied.

In additional embodiments, ordering the aggregated updates is based on the first indicator and the second indicator associated with the received updates.

In further embodiments, the ordering further comprises: generating a graph, wherein nodes of the graph represent the at least one host and the at least one storage unit, and wherein a first arc of the graph represents a first update from a first host to a first storage unit; determining if the graph is connected; and determining a total ordering of the aggregated updates, in response to the graph being connected.

In yet additional embodiments, the ordering further comprises: generating a graph, wherein nodes of the graph represent the at least one host and the at least one storage unit, and wherein a first arc of the graph represents a first update from a first host to a first storage unit; determining if the graph is connected; and determining a partial ordering of the aggregated updates, in response to the graph not being connected.

In yet further embodiments, empty updates are received from the at least one host, wherein the empty updates can allow for a total ordering of the aggregated updates.

In still further embodiments, the aggregating and ordering are performed by an application coupled to the at least one storage unit, and wherein the ordering further comprises: partitioning in a data structure the updates with respect to the at least one storage unit; and based on the first indicator and the second indicator ordering the updates in the data structure.

In further embodiments, clocks of a first host and a second host can be different, wherein if timestamps from the first host and the second host are included in the updates then the timestamps included in the updates may not be in order for consistent copying of the updates.

In still further embodiments, the plurality of updates are write operations from the at least one host to the at least one storage unit, wherein the at least one storage unit comprises a primary storage, and wherein the plurality of updates are consistently copied from the primary storage to a secondary storage coupled to the primary storage.

In additional embodiment, consistency groups can be determined in the ordered updates.

Certain embodiments achieve an ordering of data updates from a plurality of hosts to a plurality of storage devices, such that, a data consistent point across multiple update streams can be determined There is no need to use timestamps or quiescing of host applications. Embodiments may use sequence numbers generated by the hosts and the storage devices to determine an ordering of the updates across all devices. Furthermore, in certain embodiments empty updates may be written by the hosts to prevent idle systems from stopping consistent processing of data updates.

### BRIEF DESCRIPTION OF THE DRAWINGS

Referring now to the drawings in which like reference numbers represent corresponding parts throughout:

FIG. 1 illustrates a block diagram of a first computing environment, in accordance with certain described aspects of the invention;

FIG. 2 illustrates a block diagram of a second computing environment, in accordance with certain described aspects of the invention;

FIG. 3 illustrates logic for applying sequence numbers to data updates for ordering data updates, in accordance with certain described implementations of the invention;

FIG. 4 illustrates a block diagram of data updates arriving at different times, in accordance with certain described implementations of the invention;

FIG. 5 illustrates logic for ordering data updates implemented by an ordering application, in accordance with certain described implementations of the invention;

FIG. 6 illustrates a first block diagram of exemplary orderings of data updates, in accordance with certain described implementations of the invention;

FIG. 7 illustrates a second block diagram of exemplary orderings of data updates, in accordance with certain described implementations of the invention; and

FIG. 8 illustrates a block diagram of a computer architecture in which certain described aspects of the invention are implemented.

### DETAILED DESCRIPTION

In the following description, reference is made to the accompanying drawings which form a part hereof and which illustrate several implementations. It is understood that other implementations may be utilized and structural and operational changes may be made without departing from the scope of the present implementations.

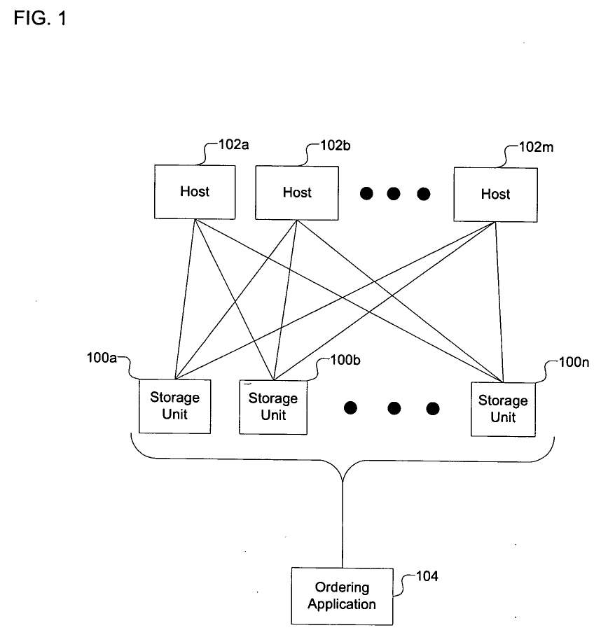

FIG. 1 illustrates a block diagram of a first computing environment, in accordance with certain aspects of the invention. A plurality of storage units 100a . . . 100n are coupled to a plurality of hosts 102a . . . 102m. The storage units 100a . . . 100n may include any storage devices and are capable of receiving Input/Output (I/O) requests from the hosts 102a . . . 102m. In certain embodiments of the invention, the coupling of the hosts 102a . . . 102m to the storage units 100a . . . 100n may include one or more storage controllers and host bus adapters. Furthermore, In certain embodiments the storage units 100a . . . 100n may collectively function as a primary storage for the hosts 102a . . . 102m. In certain embodiments where the storage units 100a . . . 100n function as a primary storage, data updates from the storage units 100a . . . 100n may be sent to a secondary storage.

An ordering application 104 coupled to the storage units 100a . . . 100n may order data updates received by the storage units 100a . . . 100n from the hosts 102a . . . 102m. For example, data updates that comprise write requests from the hosts 102a . . . 102m to the storage units 102a . . . 102n may be ordered by the ordering application 104. In certain embodiments, the ordered data updates may be sent by the ordering application to a secondary storage such that data is consistent between the secondary storage and the storage units 102a . . . 102n.

In certain embodiments, the ordering application 104 may be a distributed application that is distributed across the storage units 100a . . . 100n. In other embodiments, the ordering application 104 may reside in one or more computational units coupled to the storage units 100a . . . 100n. In yet additional embodiments, the ordering application 104 may be a distributed application that is distributed across the storage units 100a . . . 100n and across one or more computational units coupled to the storage units 100a . . . 100n.

Therefore, the block diagram of FIG. 1 illustrates an embodiment in which the ordering application 104 orders data updates associated with the storage units 100a . . . 100n, where the data updates may be written to the storage units 100a . . . 100n from the hosts 102a . . . 102m. In certain embodiments, the ordered data updates may be used to form consistency groups.

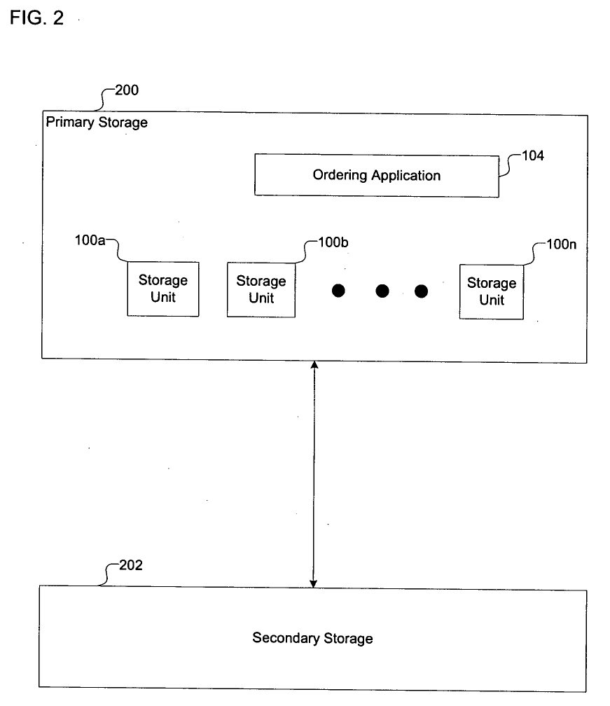

FIG. 2 illustrates a block diagram of a second computing environment, in accordance with certain described aspects of the invention. The ordering application 104 and the storage units 100a . . . 100n are associated with a primary storage 200. The primary storage 200 is coupled to a secondary storage 202, where data may be copied from the primary storage 200 to the secondary storage 202. In certain embodiments, the hosts 102a . . . 102m may perform data updates to the primary storage 200. The data updates are copied to the secondary storage 202 by the ordering application 104 or some other application coupled to the primary storage.

Data in the secondary storage 202 may need to be consistent with data in the primary storage 200. The ordering application 104 orders the data updates in the primary storage 200. The ordered data updates may be transmitted from the primary storage 200 to the secondary storage 202 in a manner such that data consistency is preserved between the secondary storage 202 and the primary storage 200.

Therefore, the block diagram of FIG. 2 describes an embodiment where the ordering application 104 performs an ordering of data updates such that data can be copied consistently from the primary storage 200 to the secondary storage 202.

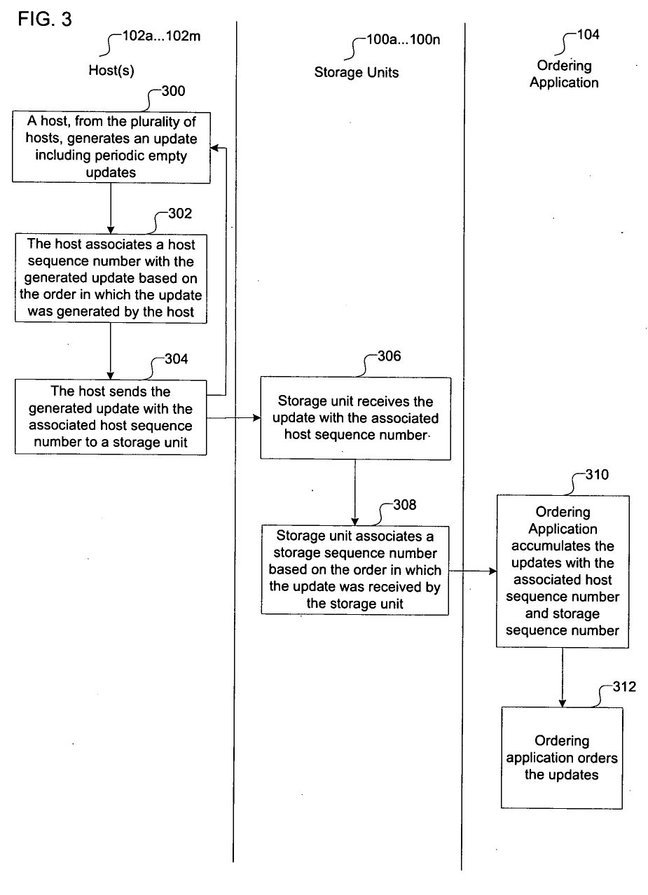

FIG. 3 illustrates logic for applying sequence numbers to data updates for ordering data updates, in accordance with certain described implementations of the invention. The logic illustrated in FIG. 3 may be implemented in the hosts 102a . . . 102m, the storage units 100a . . . 100n, and the ordering application 104.

Control starts at block 300, where a host included in the plurality of hosts 102a . . . 102m, generates a data update. In certain embodiments, the generated data update may not include any data and may be referred to as an empty update. Since each host in the plurality of hosts 102a . . . 102m may have a different clock, the embodiments do not use any timestamping of the data updates generated by the hosts 102a . . . 102n for ordering the data updates.

The host included in the plurality of hosts 102a . . . 102m associates (at block 302) a host sequence number with the generated data update based on the order in which the data update was generated by the host. For example, if the host 102a generates three data updates DA, DB, DC in sequence, then the host may associate a host sequence number one of host 102a with the data update DA, a host sequence number two of host 102a with the data update DB, and a host sequence number three of host 102a with the data update DC. Independent of host 102a, another host, such as, host 102b may also generate data updates with host sequence numbers associated with host 102b.

The host sends (at block 304) the generated data update that includes the associated host sequence number to the storage units 100a . . . 100n. A data update is associated with the update of data in a storage unit by the host. Therefore, a host sends a data update to the storage unit whose data is to be updated. For example, the data update DA with sequence number one of host 102a may be sent to the storage unit 100a. Control may continue to block 300 where the host generates a next update.

A storage unit included in the storage units 100a . . . 100n receives (at block 306) the data update with the associated sequence number. The storage unit associates (at block 308) a storage sequence number with the received data update, where the storage sequence number is based on the order in which the data update was received by the storage unit. In certain embodiments, a storage unit, such as storage unit 100a, may receive data updates from a plurality of hosts 102a . . . 102m. For example, if the data update DB with host sequence number two generated by host 102a and a data update DD with host sequence number one generated by host 102b are received one after another by the storage unit 100a, then the storage unit 100a may associate a storage sequence number one with the data update DB and a storage sequence number two with the data update DD. Other storage units besides the storage unit 100a may also independently associate storage sequence numbers with the data updates that the other storage units receive.

The ordering application 104 accumulates (at block 310) the data updates received at the storage units 100a . . . 100n. In certain embodiments, an accumulated data update includes the associated host sequence number and the storage sequence number. For example, an accumulated data update DB may include the host sequence number two generated by host 102a and the storage sequence number one generated by the storage unit 100a.

The ordering application 104 orders (at block 312) the accumulated data updates such that the ordered data updates can be applied consistently to the secondary storage 202, if the accumulated data updates are sent to the secondary storage 202 from the primary storage 200. Consistency groups can be formed from the ordered data updates. The embodiments for ordering the accumulated data updates via the ordering application 104 is described later.

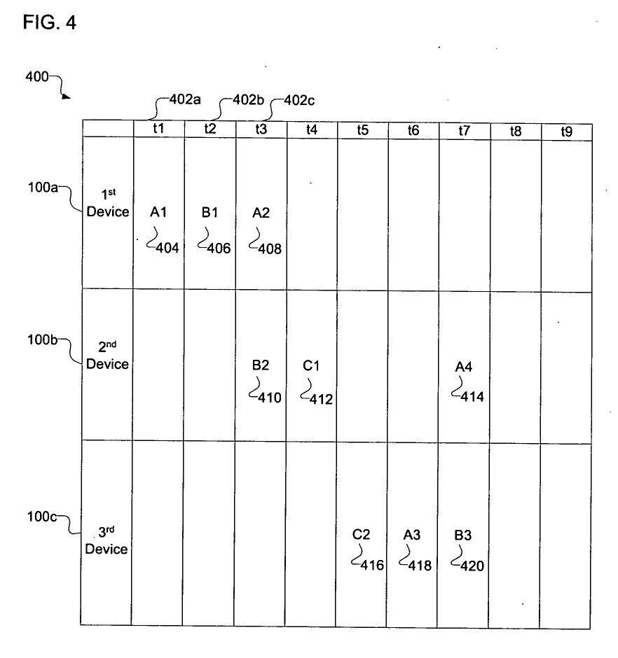

FIG. 4 illustrates a block diagram of a table 400 whose entries represent data updates arriving at different times, in accordance with certain described implementations of the invention.

The rows of the table 400 represent storage devices, such as a 1^{st} storage device 100a, a 2^{nd} storage device 100b, and a 3^{rd} storage device 100c. The columns of the table 400 represent instants of time in an increasing order of time. The times are relative times and not absolute times. For example, t1 (reference number 402a) is a time instant before t2 (reference numeral 402b), and t2 (reference number 402b) is a time instant before t3 (reference numeral 402c).

A letter-number combination in the body of the table 400 identifies an update to a device at a time, with the letter identifying a host and the number a host sequence number. For example, A1 (reference numeral 404), may represent data update with sequence number 1 generated by host A, where the update is for the 1^{st} device (reference numeral 100a) that arrives at relative time t1 (reference numeral 402a).

In certain embodiments, the ordering application 104 may generate the table 400 based on the accumulated data updates at the ordering application 104. Consistency groups of updates may be formed in the table by the ordering application 104 or a consistency group determination application. In certain embodiments, the ordering application may generate the table 400 before data updates are copied from the primary storage 200 to the secondary storage 202. The ordering application 400 may use other data structures besides the table 400 to store information similar to the information stored in the table 400.

Therefore, FIG. 4 illustrates an embodiment where the ordering application 104 generates the table 400 based on the accumulated data updates with host and storage sequence numbers.

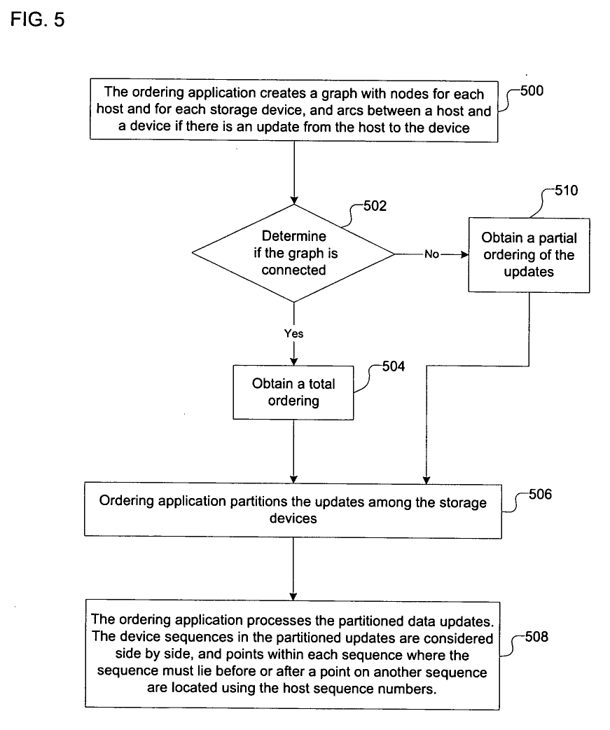

FIG. 5 illustrates logic for ordering data updates implemented by the ordering application 104, in accordance with certain described implementations of the invention.

Control starts at block 500, where the ordering application 104 may create (at block 500) a graph with nodes corresponding to each host and each storage device, where there is an arc between a host and a storage device if there is a data update from the host to the storage device.

The ordering application determines (at block 502) whether the graph is connected. If so, then the ordering application 104 obtains (at block 504) a total ordering of the data updates received at the storage devices 100a . . . 100n. Obtaining a total ordering implies that a table, such as, table 400 that is constructed by the ordering application 104, may be divided at any column of the table 400 and consistency can be guaranteed across the primary storage 200 and the secondary storage 202 if the updates till the column are made.

To obtain an ordering the ordering application 104 partitions (at block 506) the data updates received by the ordering application 104 among the storage devices 100a . . . 100n. Since the data updates are already physically divided among the storage devices 100a . . . 100n, the storage sequence numbers generated by a storage device represents a complete ordering of the data updates received at the storage device, but only a partial ordering of the data updates across all storage devices 100a . . . 100n.

The ordering application 104 processes (at block 508) the partitioned data updates. During the processing, the device sequence numbers in the partitioned updates are considered side by side, and points within each sequence where the sequence must lie before or after a point on another sequence are located using the host sequence numbers. For example, the ordering application 104 may generate the table 400 based on the processing of the partitioned data updates. The partitioned data updates corresponding to the 1^{st} device 100a are A1 (reference numeral 404), B1 (reference numeral 406), and A2 (reference numeral 408). The partitioned data updates corresponding to the 2^{nd} device 100b are B2 (reference numeral 410), C1 (reference numeral 412) and A4 (reference numeral 414). The partitioned data updates corresponding to the 3^{rd} device 100c are C2 (reference numeral 416), A3 (reference numeral 418) and B3 (reference numeral 420). In the above example, the ordering application 104 may determine that data update represented by B2 (reference numeral 410) of the partitioned data updates for the 2^{nd} device 100b would occur after the data update B1 (reference numeral 406) because the second data update of host B represented by B2 (reference numeral 410) must occur after the first update of host B represented by B1 (reference numeral 406). Consistency groups of data updates can be formed from the table 400 by the ordering application 104.

While processing to create the table 400 in block 508, the ordering application 104 may or may not be able to generated a total ordering of the data updates such that the sequence of updates can be divided at any column of the table 400 and consistency can be guaranteed across the primary storage 200 and the secondary storage 202 if the updates till the column are made. In certain embodiments where empty updates are sent by the hosts 100a . . . 100m a total ordering may always be possible.

If the ordering application 104 determines (at block 502) that the graph is not connected then the ordering application 104 obtains (at block 510) a partial ordering of the updates. To obtain the partial ordering control proceeds to block 506 and then to block 508. The table 400 constructed in block 400 may only be divided along certain columns to guarantee consistency across the primary storage 200 and the secondary storage 102 if the updates till the certain columns are made.

Therefore, the logic of FIG. 5 describes an embodiment to create an ordering of the data updates for maintaining consistency between the primary storage 200 and the secondary storage 202.

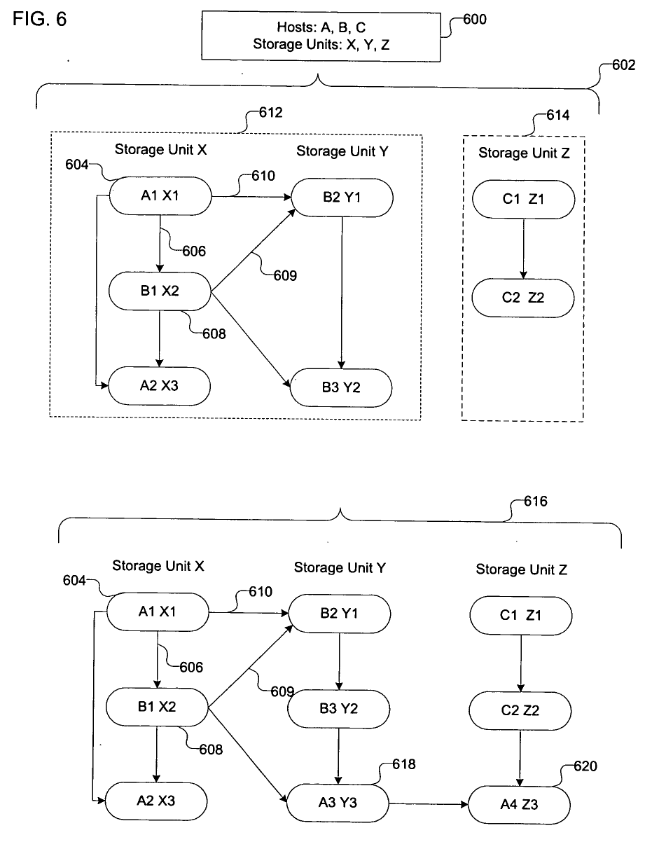

FIG. 6 illustrates a first block diagram of exemplary orderings of data updates, in accordance with certain described implementations of the invention. Block 600 illustrates three exemplary hosts A, B, C and three exemplary storage units X, Y, Z.

In FIG. 6, the nodes of a graphs 602 and 616 are represented with a notation HiSj, where HiSj is a data update from the host H with host sequence number i, written to the Storage S with storage sequence number j being associated with the data update. For example, “A1 X1” (reference numeral 604) is an update with associated host sequence number 1 generated by host A and storage sequence number 1 generated by storage unit X. A directed arc in the graphs 602, 616 denotes that the node being pointed from is at a time before the node being pointed to by the directed arc. For example, arrow 606 is an example of an ordering by the ordering application 104 that indicates that node “B1 X2” (reference numeral 608) can potentially occur after node “A1 X1” (reference numeral 604) as node “B1 X2” (reference number 608) has a higher storage sequence number corresponding to the same storage unit X than node “A1 X1” (reference numeral 604). Certain orderings, such as the ordering represented by arc 610 may be inferred from other arcs. In the case of the ordering represented by arc 610, the inference can be derived because of the transitivity property from arcs 606 and 609 that collectively allow for the inference of arc 610.

Graph 602 is not completely connected. The nodes represented by reference numeral 612 are connected and the nodes represented by reference numeral 614 are connected. Therefore, in the graph 602 the ordering application 104 cannot determine how to totally order the nodes represented by reference numeral 614 with respect to the nodes represented by the reference numeral 612. However the nodes represented by reference numeral 612 can be ordered among themselves. Similarly, the nodes represented by reference numeral 614 can be ordered among themselves.

In case there are additional updates, such as, updates in graph 616 represented by nodes with reference numerals 618 and 620, then a total ordering is possible for the nodes as graph 616 can be completely connected. Therefore, there is some update for which there is no preceding update that is not available. In graph 616 going backward from node “A4 Z4” (reference numeral 620) a consecutive series of updates may be constructed for maintaining consistency across the primary storage 200 and the secondary storage 202.

In certain embodiments the nodes with reference numerals 618 and 620 may represent the additional updates from the hosts 102a . . . 102m that allow the ordering of the updates for consistency.

Therefore, FIG. 6 illustrates an exemplary embodiment to perform ordering of updates by the ordering application 104. In certain embodiments, additional updates may allow a total ordering, where no total ordering is otherwise possible.

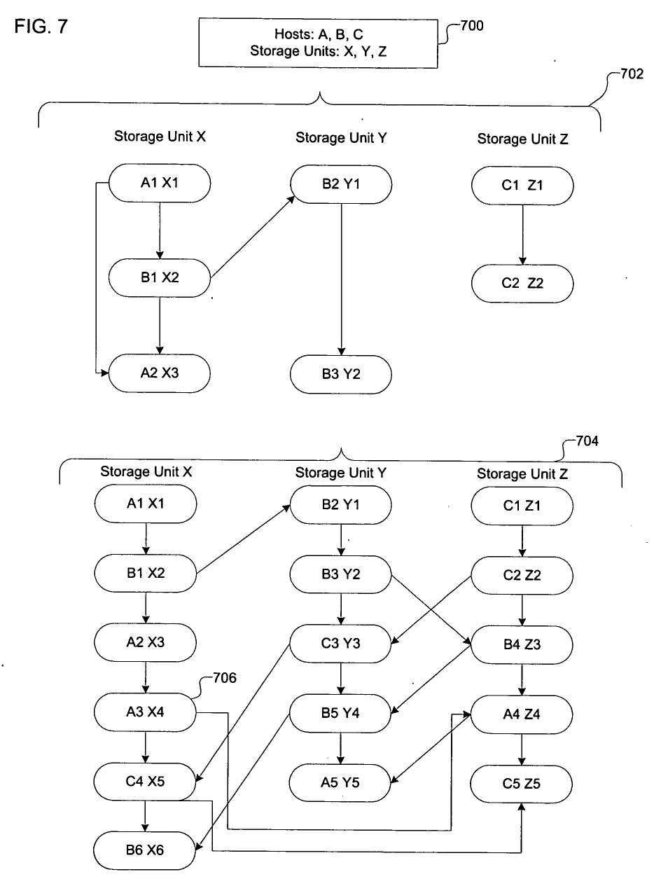

FIG. 7 illustrates a second block diagram of exemplary orderings of data updates, in accordance with certain described implementations of the invention. Block 700 illustrates three exemplary hosts A, B, C and three exemplary storage units X, Y, Z.

In the embodiment represented by the nodes and arcs of graph 702, an ordering is not possible. However, in the embodiment represented by the graph 704, each of the hosts A, B, C updates the sequence number for each storage unit by writing empty updates. For example, in the embodiment represented by graph 704, node “A3 X4” (reference numeral 706) is one of the representative empty updates that is not present in the embodiment represented by graph 702. As a result of the additional empty updates, the ordering application 104 can determine a total ordering of the data updates in the embodiment represented by graph 704.

Therefore, graph 704 of FIG. 7 illustrates an exemplary embodiment to perform a total ordering of updates by incorporating empty updates. In certain embodiments, without such additional empty updates, no total ordering may be possible.

Certain embodiments achieve an ordering of data updates from a plurality of hosts to a plurality of storage devices, such that, a data consistent point across multiple update streams can be determined. There is no need to use timestamps or quiescing of host applications. Embodiments may use sequence numbers generated by the hosts and storage controls to determine an ordering of the updates across all devices. Furthermore, in certain embodiments empty updates may be written to prevent idle systems from stopping consistent processing of data updates.

The embodiments capture enough information about an original sequence of writes to storage units to be able to order updates, such that for any update which is dependent on an earlier update, the ordering application 104 can determine that the earlier update has a position in the overall order somewhere before the dependent update. To create a consistency group it is sufficient to locate a point in each of the concurrent update streams from a plurality of hosts to a plurality of storage units for which it is known that for any dependent write before the chosen point, all data that update depends on is also before the chosen point.

### Additional Implementation Details

The described techniques may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium, such as hard disk drives, floppy disks, tape), optical storage (e.g., CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which implementations are made may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the implementations, and that the article of manufacture may comprise any information bearing medium known in the art.

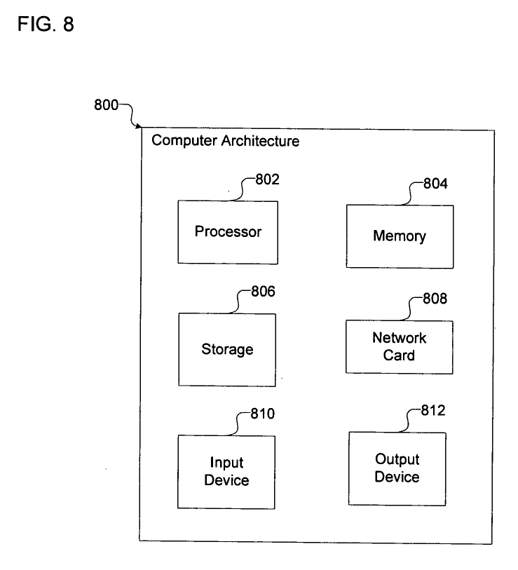

FIG. 8 illustrates a block diagram of a computer architecture in which certain aspects of the invention are implemented. FIG. 8 illustrates one implementation of the storage controls associated with the storage units 100a . . . 100n, the host 102a . . . 102m, and any computational device that includes all or part of the ordering application 104. Storage controls associated with the storage units 100a . . . 100n, the hosts 102a . . . 102m, and any computational device that includes all or part of the ordering application 104 may implement a computer architecture 800 having a processor 802, a memory 804 (e.g., a volatile memory device), and storage 806 (e.g., a non-volatile storage, magnetic disk drives, optical disk drives, tape drives, etc.). The storage 806 may comprise an internal storage device, an attached storage device or a network accessible storage device. Programs in the storage 806 may be loaded into the memory 804 and executed by the processor 802 in a manner known in the art. The architecture may further include a network card 808 to enable communication with a network. The architecture may also include at least one input device 810, such as a keyboard, a touchscreen, a pen, voice-activated input, etc., and at least one output device 812, such as, a display device, a speaker, a printer, etc.

FIGS. 3, 5, 6, and 7 describe specific operations occurring in a particular order. Further, the operations may be performed in parallel as well as sequentially. In alternative implementations, certain of the logic operations may be performed in a different order, modified or removed and still implement implementations of the present invention. Morever, steps may be added to the above described logic and still conform to the implementations. Yet further steps may be performed by a single process or distributed processes.

Many of the software and hardware components have been described in separate modules for purposes of illustration. Such components may be integrated into a fewer number of components or divided into a larger number of components. Additionally, certain operations described as performed by a specific component may be performed by other components.

In additional embodiments of the invention vendor unique commands may identify each update's host of origin and host sequence number. Device driver software may prepend or append the vendor unique command to each write. The device driver software may periodically perform an empty update to all configured storage units participating in the system, either in a timer driven manner or via software. The ordering application may also configure the device drivers and work in association with a consistency group formation software.

Therefore, the foregoing description of the implementations has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

1. A method, comprising:
receiving, by at least one storage unit, a plurality of updates from at least one host, wherein a received update includes a first indicator that indicates an order in which the received update was generated by a host;
associating a second indicator with the received update based on an order in which the received update was received by a storage unit;
aggregating the plurality of updates received by the at least one storage unit; and
ordering the aggregated updates, wherein the ordered updates can be consistently copied.

2. The method of claim 1, wherein ordering the aggregated updates is based on the first indicator and the second indicator associated with the received updates.

3. The method of claim 1, wherein the ordering further comprises:
generating a graph, wherein nodes of the graph represent the at least one host and the at least one storage unit, and wherein a first arc of the graph represents a first update from a first host to a first storage unit;
determining if the graph is connected; and
determining a total ordering of the aggregated updates, in response to the graph being connected.

4. The method of claim 1, wherein the ordering further comprises:
generating a graph, wherein nodes of the graph represent the at least one host and the at least one storage unit, and wherein a first arc of the graph represents a first update from a first host to a first storage unit;
determining if the graph is connected; and
determining a partial ordering of the aggregated updates, in response to the graph not being connected.

5. The method of claim 1, further comprising:
receiving empty updates from the at least one host, wherein the empty updates can allow for a total ordering of the aggregated updates.

6. The method of claim 1, wherein the aggregating and ordering are performed by an application coupled to the at least one storage unit, and wherein the ordering further comprises:
partitioning in a data structure the updates with respect to the at least one storage unit; and
based on the first indicator and the second indicator ordering the updates in the data structure.

7. The method of claim 1, wherein clocks of a first host and a second host can be different, wherein if timestamps from the first host and the second host are included in the updates then the timestamps included in the updates may not be in order for consistent copying of the updates.

8. The method of claim 1, wherein the plurality of updates are write operations from the at least one host to the at least one storage unit, wherein the at least one storage unit comprises a primary storage, and wherein the plurality of updates are consistently copied from the primary storage to a secondary storage coupled to the primary storage.

9. The method of claim 1, wherein consistency groups can be determined in the ordered updates.

10. A system, comprising:
at least one storage unit;
at least one processor coupled to the at least one storage unit; and
program logic including code capable of causing the at least one processor to perform:
(i) receiving, by the at least one storage unit, a plurality of updates, wherein a received update includes a first indicator that indicates an order in which the received update was generated;
(ii) associating a second indicator with the received update based on an order in which the received update was received by a storage unit;
(iii) aggregating the plurality of updates received by the at least one storage unit; and
(iv) ordering the aggregated updates, wherein the ordered updates can be consistently copied.

11. The system of claim 10, wherein ordering the aggregated updates is based on the first indicator and the second indicator associated with the received updates.

12. The system of claim 10, further comprising:
at least one host coupled to the first storage unit; and
a graph associated with the at least one storage unit, wherein nodes of the graph represent the at least one host and the at least one storage unit, and wherein a first arc of the graph represents a first update from a first host to a first storage unit, and wherein the ordering further comprises:
(i) generating a graph;
(ii) determining if the graph is connected; and
(iii) determining a total ordering of the aggregated updates, in response to the graph being connected.

13. The system of claim 10, further comprising:
at least one host coupled to the at least one storage unit; and
a graph associated with the at least one storage unit, wherein nodes of the graph represent the at least one host and the at least one storage unit, and wherein a first arc of the graph represents a first update from a first host to a first storage unit, and wherein the ordering further comprises:
(i) generating the graph;
(ii) determining if the graph is connected; and
(iii) determining a partial ordering of the aggregated updates, in response to the graph not being connected.

14. The system of claim 10, wherein the program logic is further capable of causing the at least one processor to perform:
receiving empty updates, wherein the empty updates can allow for a total ordering of the aggregated updates.

15. The system of claim 10, further comprising:
an application coupled to the at least one storage unit, wherein the aggregating and ordering are performed by the application, and wherein ordering the aggregated updates further comprises:
(i) partitioning in a data structure the updates with respect to the at least one storage unit; and
(ii) based on the first indicator and the second indicator ordering the updates in the data structure.

16. The system of claim 10, further comprising:
a first host coupled to the at least one storage unit;
a second host coupled to the at least one storage unit; and
clocks of the first host and the second host, wherein the clocks can be different, wherein if timestamps from the first host and the second host are included in the updates then the timestamps included in the updates may not be in order for consistent copying of the updates.

17. The system of claim 10, further comprising:
at least one host coupled to the at least one storage unit;
a primary storage, wherein the plurality of updates are write operations from the at least one host to the at least one storage unit, wherein the at least one storage unit comprises the primary storage; and
a secondary storage coupled to the primary storage, wherein the plurality of updates are consistently copied from the primary storage to the secondary storage.

18. The system of claim 10, further comprising:
at least one host coupled to the at least one storage unit, wherein the plurality of updates are received from the at least one host, and wherein consistency groups can be determined in the ordered updates.

19. An article of manufacture for ordering updates received by at least one storage unit from at least one host, wherein the article of manufacture is capable of causing operations, the operations comprising:
receiving, by the at least one storage unit, a plurality of updates from the at least one host, wherein a received update includes a first indicator that indicates an order in which the received update was generated by a host;
associating a second indicator with the received update based on an order in which the received update was received by a storage unit;
aggregating the plurality of updates received by the at least one storage unit; and
ordering the aggregated updates, wherein the ordered updates can be consistently copied.

20. The article of manufacture of claim 19, wherein ordering the aggregated updates is based on the first indicator and the second indicator associated with the received updates.

21. The article of manufacture of claim 19, wherein the ordering further comprises:
generating a graph, wherein nodes of the graph represent the at least one host and the at least one storage unit, and wherein a first arc of the graph represents a first update from a first host to a first storage unit;
determining if the graph is connected; and
determining a total ordering of the aggregated updates, in response to the graph being connected.

22. The article of manufacture of claim 19, wherein the ordering further comprises:
generating a graph, wherein nodes of the graph represent the at least one host and the at least one storage unit, and wherein a first arc of the graph represents a first update from a first host to a first storage unit;
determining if the graph is connected; and
determining a partial ordering of the aggregated updates, in response to the graph not being connected.

23. The article of manufacture of claim 19, the operations further comprising:
receiving empty updates from the at least one host, wherein the empty updates can allow for a total ordering of the aggregated updates.

24. The article of manufacture of claim 19, wherein the aggregating and ordering are performed by an application coupled to the at least one storage unit, and wherein the ordering further comprises:
partitioning in a data structure the updates with respect to the at least one storage unit; and
based on the first indicator and the second indicator ordering the updates in the data structure.

25. The article of manufacture of claim 19, wherein clocks of a first host and a second host can be different, wherein if timestamps from the first host and the second host are included in the updates then the timestamps included in the updates may not be in order for consistent copying of the updates.

26. The article of manufacture of claim 19, wherein the plurality of updates are write operations from the at least one host to the at least one storage unit, wherein the at least one storage unit comprises a primary storage, and wherein the plurality of updates are consistently copied from the primary storage to a secondary storage coupled to the primary storage.

27. The article of manufacture of claim 19, wherein consistency groups can be determined in the ordered updates.

28. A system, comprising:
means for receiving a plurality of updates, wherein a received update includes a first indicator that indicates an order in which the received update was generated;
means for associating a second indicator with the received update based on an order in which the received update was received;
means for aggregating the received plurality of updates; and
means for ordering the aggregated updates, wherein the ordered updates can be consistently copied.

29. The system of claim 28, further comprising:
means for receiving empty updates, wherein the empty updates can allow for a total ordering of the aggregated updates.

30. The system of claim 28, further comprising:
an application, wherein the aggregating and ordering are performed by the application, and wherein the means for ordering further performs:
(i) partitioning in a data structure the updates; and
(ii) based on the first indicator and the second indicator ordering the updates in the data structure.

31. The system of claim 28, further comprising at least one host, wherein the plurality of updates are received from the at least one host, wherein the first indicator includes the order in which the received update was generated by the at least one host.
